(19) United States
(12) Patent Application Publication
(10) Pub. No.: US 2011/0081188 A1
(43) Pub. Date: Apr. 7, 2011

(54) IMAGE FORMING APPARATUS

(76) Inventor: Shinya KASEDA, Tokyo (JP)

(21) Appl. No.: 12/899,666

(22) Filed: Oct. 7, 2010

(30) Foreign Application Priority Data
Oct. 7, 2009 (JP) 2009-233036

(51) Int. Cl. B41J 11/02

(52) U.S. Cl. 400/611

(57) ABSTRACT

An image forming apparatus includes a first transportation unit for transporting a medium; a second transportation unit including a first transportation member and a second transportation member disposed on both sides of a transportation path of the medium on a downstream side of the first transportation unit in a transportation direction of the medium for transporting the sheet supplied from the first transportation unit; and a medium guiding portion disposed between the first transportation unit and the second transportation unit for guiding the medium supplied from the first transportation unit toward the second transportation unit. The medium guiding portion includes a guide surface formed to face the transportation path for guiding the medium toward the first transportation member of the second transportation unit.

### BACKGROUND OF THE INVENTION AND RELATED ART STATEMENT

The present invention relates to an image forming apparatus.

In a conventional image forming apparatus such as a printer of an electro-photography type, a facsimile, a copier, and an MFP (a multi function peripheral or product), a charging roller uniformly charges a surface of a photosensitive drum. Then, an LED (Light Emitting Diode) exposes the surface of the photosensitive drum to form a static latent image thereon. After a developing device develops the static latent image to form a toner image on the photosensitive drum, the toner image is transferred and fixed to a sheet.

In the conventional image forming apparatus, the toner image may be transferred to the sheet through one of the following two processes. In the first process, the toner image on the photosensitive drum is directly transferred to the sheet. In the second process, the toner image on the photosensitive drum is temporarily transferred to an intermediate transfer belt in a first transfer section, and the toner image transferred to the intermediate transfer belt is transferred to the sheet in a second transfer section.

In the conventional image forming apparatus, the second transfer section includes a pair of rollers, so that the rollers sandwich the sheet, thereby transferring the toner image to the sheet in the second process. A guide member is disposed on an upstream side of the second transfer section in a transportation direction of the sheet, so that the guide member guides the sheet to the second transfer unit (Refer to Patent Reference).

Patent Reference: Japanese Patent Publication No. 2006-113275

In the conventional image forming apparatus described above, when the sheet is transported and a leading edge of the sheet is deviated with respect to the transportation direction due to vibration and the like, the leading edge of the sheet may abut against the toner image unfixed on the intermediate transfer belt before the sheet is transported into the second transfer section, thereby distorting the toner image. Accordingly, it is not possible to form an image in an appropriate state, thereby deteriorating image quality.

In view of the problems described above, an object of the present invention is to provide an image forming apparatus capable of solving the problems of the conventional image forming apparatus. In the present invention, it is possible to form an image without distortion, thereby improving image quality.

Further objects and advantages of the invention will be apparent from the following description of the invention.

### SUMMARY OF THE INVENTION

In order to attain the objects described above, according to an aspect of the present invention, an image forming apparatus includes a first transportation unit for transporting a medium; a second transportation unit including a first transportation member and a second transportation member disposed on both sides of a transportation path of the medium on a downstream side of the first transportation unit in a transportation direction of the medium for transporting the sheet supplied from the first transportation unit; and a medium guiding portion disposed between the first transportation unit and the second transportation unit for guiding the medium supplied from the first transportation unit toward the second transportation unit.

According to the aspect of the present invention, the medium guiding portion includes a guide surface formed to face the transportation path for guiding the medium toward the first transportation member of the second transportation unit.

As described above, in the aspect of the present invention, the image forming apparatus includes the first transportation unit for transporting the medium; the second transportation unit including the first transportation member and the second transportation member disposed on the both sides of the transportation path of the medium on the downstream side of the first transportation unit in the transportation direction of the sheet for transporting the sheet supplied from the first transportation unit; and the medium guiding portion disposed between the first transportation unit and the second transportation unit for guiding the medium supplied from the first transportation unit toward the second transportation unit.

Further, in the aspect of the present invention, the medium guiding portion includes the guide surface formed to face the transportation path for guiding the medium toward the first transportation member of the second transportation unit.

In this case, the medium guiding portion includes the guide surface formed to face the transportation path for guiding the medium toward the first transportation member of the second transportation unit. Accordingly, even when the medium is transported and vibration is generated, it is possible to prevent a leading edge of the medium from deviating from the transportation direction. As a result, it is possible to prevent the leading edge of the medium from abutting against a developer image unfixed, and to form an image without distortion, thereby improving image quality.

Further, in the image forming apparatus, it is possible to prevent a jam or the medium from being winkled, thereby making it possible to smoothly transport the medium.

### BRIEF DESCRIPTION OF THE DRAWINGS

FIG. 1 is a schematic view showing a transportation system of a color printer according to a first embodiment of the present invention;

FIG. 2 is a schematic sectional view showing a configuration of the color printer according to the first embodiment of the present invention;

FIG. 3 is a block diagram showing a control system of the color printer according to the first embodiment of the present invention;

FIG. 4 is a schematic view No. 1 showing an operation of the transportation system of the color printer according to the first embodiment of the present invention;

FIG. 5 is a schematic view No. 2 showing the operation of the transportation system of the color printer according to the first embodiment of the present invention;

FIG. 6 is a schematic view No. 3 showing the operation of the transportation system of the color printer according to the first embodiment of the present invention;

FIG. 7 is a schematic view No. 4 showing the operation of the transportation system of the color printer according to the first embodiment of the present invention;

FIG. 8 is a schematic view showing a transportation system of a color printer according to a second embodiment of the present invention;

FIG. 9 is a schematic view No. 1 showing an operation of the transportation system of the color printer according to the second embodiment of the present invention;

FIG. 10 is a schematic view No. 2 showing the operation of the transportation system of the color printer according to the second embodiment of the present invention;

FIG. 11 is a schematic view No. 3 showing the operation of the transportation system of the color printer according to the second embodiment of the present invention;

FIG. 12 is a schematic view No. 4 showing the operation of the transportation system of the color printer according to the second embodiment of the present invention;

FIG. 13 is a schematic view No. 5 showing the operation of the transportation system of the color printer according to the second embodiment of the present invention;

FIG. 14 is a schematic view No. 6 showing the operation of the transportation system of the color printer according to the second embodiment of the present invention;

FIG. 15 is a schematic view No. 7 showing the operation of the transportation system of the color printer according to the second embodiment of the present invention;

FIG. 16 is a schematic view showing a transportation system of a color printer according to a third embodiment of the present invention;

FIG. 17 is a schematic view No. 1 showing an operation of the transportation system of the color printer according to the third embodiment of the present invention;

FIG. 18 is a schematic view No. 2 showing the operation of the transportation system of the color printer according to the third embodiment of the present invention;

FIG. 19 is a schematic view No. 3 showing the operation of the transportation system of the color printer according to the third embodiment of the present invention;

FIG. 20 is a schematic view No. 4 showing the operation of the transportation system of the color printer according to the third embodiment of the present invention;

FIG. 21 is a schematic view No. 5 showing the operation of the transportation system of the color printer according to the third embodiment of the present invention;

FIG. 22 is a schematic view showing a transportation system of a color printer according to a fourth embodiment of the present invention;

FIG. 23 is a block diagram showing a control system of the color printer according to the fourth embodiment of the present invention;

FIG. 24 is a schematic view No. 1 showing an operation of the transportation system of the color printer according to the fourth embodiment of the present invention;

FIG. 25 is a schematic view No. 2 showing the operation of the transportation system of the color printer according to the fourth embodiment of the present invention;

FIG. 26 is a schematic view No. 3 showing the operation of the transportation system of the color printer according to the fourth embodiment of the present invention;

FIG. 27 is a schematic view No. 4 showing the operation of the transportation system of the color printer according to the fourth embodiment of the present invention; and

FIG. 28 is a schematic view No. 5 showing the operation of the transportation system of the color printer according to the fourth embodiment of the present invention.

### DETAILED DESCRIPTION OF PREFERRED EMBODIMENTS

Hereunder, embodiments of the present invention will be explained with reference to the accompanying drawings. In the following description, a color printer will be explained as an image forming apparatus.

### First Embodiment

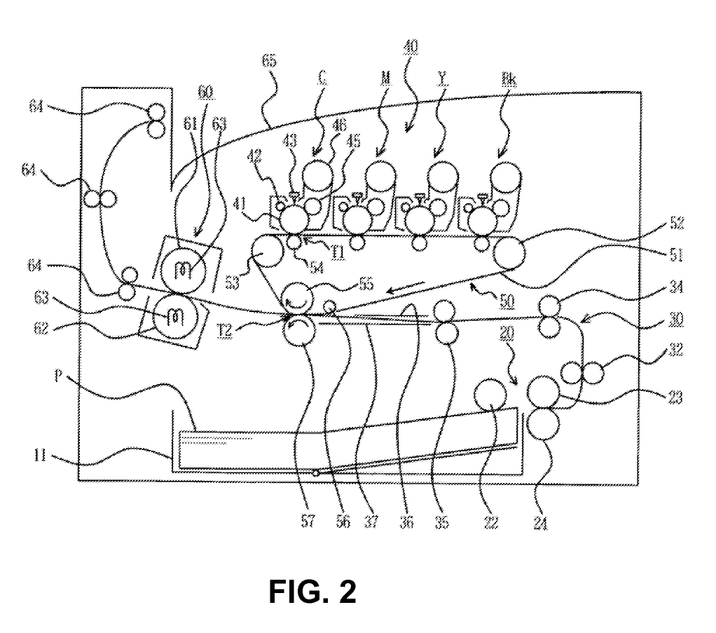

According to a first embodiment of the present invention, a configuration of a color printer will be explained with reference to FIG. 2. FIG. 2 is a schematic sectional view showing a configuration of the color printer according to the first embodiment of the present invention.

As shown in FIG. 2, the color printer includes a sheet cassette 11 (a sheet tray) as a medium storage unit for retaining a sheet P. The sheet cassette 11 is detachably attached to a main body or an apparatus main body of the color printer. A sheet pickup unit 20 is disposed at a front end portion of the sheet cassette 11 for separating and picking up the sheet P one by one.

More specifically, the sheet pickup unit 20 is arranged to abut against the sheet P at an uppermost position. The sheet pickup unit 20 includes a hopping roller 22 (a pickup roller) for picking up the sheet P while rotating, and a pair of a feed roller 23 and a retard roller 24 for separating the sheet P one by one picked up with the hopping roller 22. A sheet supply motor (not shown) as a sheet supply drive unit drives the hopping roller 22 to rotate. It is noted that the hopping roller 22 constitutes a pickup section, and the feed roller 23 and the retard roller 24 constitute a separation section.

In the embodiment, the color printer further includes a sheet transportation unit 30 as a first transportation unit for transporting the sheet P picked up and supplied from the sheet pickup unit 20. Further, the color printer includes an image forming portion 40. The image forming portion 40 includes image forming units C, M, Y, and Bk arranged in series, and LED (Light Emitting Diode) heads 43 as an exposure unit. In the image forming portion 40, the image forming units C, M, Y, and Bk and the LED heads 43 form toner images as developer images in colors of cyan, magenta, yellow, and black.

In the embodiment, the color printer further includes a transfer unit 50 having an intermediate transfer belt 51 as a belt member. The toner images in colors are sequentially transferred and overlapped on the intermediate transfer belt 51, thereby forming a color toner image. Then, the transfer unit 50 transfers the color toner image on the intermediate transfer belt 51 to the sheet P transported with the sheet transportation unit 30. Further, the color printer includes a fixing device 60 for heating and pressing the color toner image transferred to the sheet P, so that the color toner image is fixed to the sheet P, thereby forming a color image on the sheet P.

In the embodiment, the color printer further includes discharge roller pairs 64 for discharging the sheet P discharged from the fixing device 60 to outside the apparatus main body, and a stacker portion 65 for placing the sheet P discharged with the discharge roller pairs 64 to outside the apparatus main body.

In the embodiment, the sheet transportation unit 30 includes transportation roller pairs 32, 34, and 35 as a first transportation component arranged from an upstream side to a downstream side in the transportation direction of the sheet P. A transportation motor (not shown) as a transportation drive unit drives the transportation roller pairs 32, 34, and 35 to rotate.

In the image forming portion 40, each of the image forming units C, M, Y, and Bk includes a photosensitive drum 41 for supporting the toner image; a charging roller 42 as a charging device for uniformly charging a surface of the photosensitive drum 41 with negative polarity; a developing roller 45 for developing the static latent image formed on the surface of the photosensitive drum 41 to form the toner image; and a toner storage portion 46 as a developer storage portion for retaining toner as developer. A drum motor (not shown) as an image forming drive unit drives the photosensitive drum 41 to rotate.

In the embodiment, the photosensitive drum 41 constitutes a first image supporting member, and the intermediate transfer belt 51 constitutes a second image supporting member. It is noted that the LED head 43 irradiates and exposes the surface of the photosensitive drum 41 to form the static latent image thereon.

In the embodiment, the transfer unit 50 includes the intermediate transfer belt 51; a drive roller 52 as a first roller; a tension roller 53 as a second roller for applying tension to the intermediate transfer belt 51; and a back-up roller 55 as a third roller. Further, the transfer unit 50 includes primary transfer rollers 54 as a first transfer member or a first transfer roller arranged to face the photosensitive drums 41 of the image forming units C, M, Y, and Bk with the intermediate transfer belt 51 in between; a secondary transfer roller 57 as a second transfer member or a second transfer roller arranged to abut against the back-up roller 55 with the intermediate transfer belt 51 in between for forming a nip portion with the back-up roller 55; and a support roller 56 as a fourth roller disposed inside the intermediate transfer belt 51 adjacent to the back-up roller 55 for adjusting a contact area between the intermediate transfer belt 51 and the secondary transfer roller 57.

In the embodiment, the intermediate transfer belt 51 is extended with the drive roller 52, the tension roller 53, and the secondary transfer roller 57 to move in an arrow direction. A belt motor (not shown) as a belt drive unit drives the drive roller 52 to rotate, so that the intermediate transfer belt 51 moves. It is noted that the tension roller 53 is arranged on an upstream side of the drive roller 52; the back-up roller 55 is arranged on an upstream side of the tension roller 53; and the support roller 56 is arranged on an upstream side of the back-up roller 55 in a moving direction of the intermediate transfer belt 51. The secondary transfer roller 57 constitutes a first transportation member, and the back-up roller 55 and the support roller 56 constitute a second transportation member.

In the embodiment, a primary transfer section T1 as a first transfer section is formed between each of the photosensitive drums 41 and each of the primary transfer rollers 54. In the primary transfer section T1, when the intermediate transfer belt 51 moves, the toner images in colors on the photosensitive drums 41 are sequentially transferred and overlapped (primary transfer) on the intermediate transfer belt 51 through coulomb force, thereby forming the color toner image thereon.

More specifically, a power source device applies a voltage to the primary transfer rollers 54 to form an electrical filed between the photosensitive drums 41 and the primary transfer rollers 54, so that the toner images in colors are transferred to the intermediate transfer belt 51 through the electrical field. It is noted that the drum motor and the belt motor drive the photosensitive drums 41 and the drive roller 52 to rotate in synchronization.

In the embodiment, a secondary transfer section T2 as a second transfer section is formed between the intermediate transfer belt 51 and the back-up roller 55, and the secondary transfer roller 57. In the secondary transfer section T2, the color toner image on the intermediate transfer belt 51 is transferred (secondary transfer) to the sheet P through coulomb force. More specifically, a power source device applies a voltage to the secondary transfer roller 57 to form an electrical filed between the secondary transfer roller 57 and the back-up roller 55 grounded, so that the color toner image is transferred to the sheet P through the electrical field.

In the embodiment, a primary transfer motor (not shown) as a first transfer drive unit drives the primary transfer rollers 54 to rotate, and a secondary transfer motor (not shown) as a second transfer drive unit drives the back-up roller 55 to rotate. It is noted that the secondary transfer roller 57 is arranged to follow a movement of the intermediate transfer belt 51 and a rotation of the back-up roller 55 to rotate. Alternatively, a transfer motor (not shown) may be provided as a third transfer drive unit for driving the secondary transfer roller 57 to rotate.

In the embodiment, in the secondary transfer section T2, the intermediate transfer belt 51, the back-up roller 55, and the secondary transfer roller 57 constitute a second transportation unit disposed on a downstream side of the sheet transportation unit 30 in the transportation direction of the sheet P for transporting the sheet P supplied from the sheet transportation unit 30. It is noted that, in the secondary transfer section T2, the back-up roller 55 and the secondary transfer roller 57 are arranged to face each other in a direction perpendicular to the movement direction of the intermediate transfer belt 51 and the transportation direction of the sheet P.

In the embodiment, an upper side guide member 36 as a first guide member is disposed between the transportation roller pair 35 and the secondary transfer section T2 for guiding the sheet P. Further, a lower side guide member 37 as a second guide member is disposed between the transportation roller pair 35 and the secondary transfer section T2 for guiding the sheet P.

In the embodiment, the fixing device 60 includes an upper roller 61 as a first fixing roller, and a lower roller 62 as a second fixing roller. Each of the upper roller 61 and the lower roller 62 has a surface layer formed of an elastic material, and is provided with a halogen lamp 63 as a heat source or a heating member therein.

As shown in FIG. 2, the transportation path of the sheet P is represented with a solid line passing through between the feed roller 23 and the retard roller 24; between the transportation roller pairs 32, 34, and 35; between the upper side guide member 36 and the lower side guide member 37; between the secondary transfer roller 57 and the intermediate transfer belt 51; between the upper roller 61 and the lower roller 62; and between the discharge roller pairs 64.

An operation of the color printer with the configuration described above will be explained next. First, the sheet supply motor is turned on to drive the hopping roller 22 in the sheet pickup unit 20 to rotate. Accordingly, the sheet P is picked up from the sheet cassette 11 and transported to a nip portion of the feed roller 23 and the retard roller 24, so that the sheet P is separated one by one. After the sheet P is transported to the sheet transportation unit 30, the transportation roller pairs 32, 34, and 35 transport the sheet P to the secondary transfer section T2.

In the next step, in each of the image forming units C, M, Y, and Bk of the image forming portion 40, the charging roller 42 uniformly charges the surface of the photosensitive drum 41 with negative polarity. Then, the LED head 43 irradiates and exposes the surface of the photosensitive drum 41 to form the static latent image thereon. In the next step, toner is supplied from the toner storage portion 46, and the developing roller 45 attaches toner to the photosensitive drum 41 for developing the static latent image, thereby forming the toner image on the surface of the photosensitive drum 41. Afterward, each of the primary transfer rollers 54 sequentially overlaps and transfers the toner image in each color on the photosensitive drum 41 to the intermediate transfer belt 51, thereby forming the color toner image.

In the next step, as the intermediate transfer belt 51 moves, the color toner image transferred to the intermediate transfer belt 51 moves to the secondary transfer section T2, so that the color toner image is transferred to the sheet P in the secondary transfer section T2. Then, the sheet P is transported to the fixing device 60, so that the fixing device 60 fixes the color toner image to the sheet P, thereby forming the color image on the sheet P. Afterward, the discharge roller pairs 64 discharges the sheet P to the stacker portion 65.

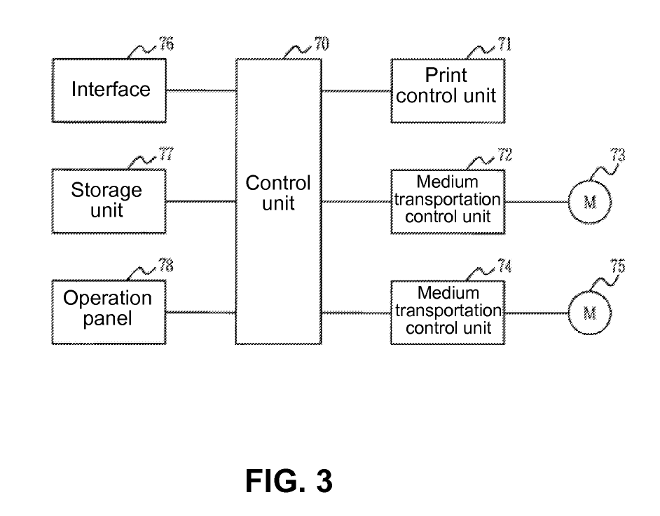

A control system of the color printer with the configuration described above will be explained next. FIG. 3 is a block diagram showing the control system of the color printer according to the first embodiment of the present invention.

As shown in FIG. 3, the control system of the color printer includes a control unit 70 for controlling an entire operation of the color printer; an interface 76 for receiving and transmitting information with respect to an external device (such as a host computer); a storage unit 77 for storing information for operating the color printer and information received from the external device; and an operation panel 78 as a user interface functioning as an operation portion and a display portion for displaying a setting content of the color printer and a state of the color printer.

In the embodiment, the control system of the color printer further includes a medium transportation control unit 72 as a first transportation control unit for driving a transportation motor 73 to rotate the transportation roller pairs 32, 34, and 35 (refer to FIG. 2) to control the sheet transportation unit 30 to transport the sheet P; a medium transportation control unit 74 as a second transportation control unit for driving a belt motor 75 to rotate the drive roller 52 to move the intermediate transfer belt 51, and for controlling the transportation of the sheet P at the secondary transfer section T2; and a print control unit 71 for forming, transferring, and fixing the toner image with respect to the sheet P.

In the embodiment, the medium transportation control unit 72 and the medium transportation control unit 74 control rotational speeds of the transportation motor 73 and the belt motor 75 such that the sheet transportation unit 30 transports the sheet P at a transportation speed higher than that of the secondary transfer section T2, thereby forming a slack of the sheet P between the sheet transportation unit 30 and the secondary transfer section T2. Accordingly, it is possible to prevent the sheet P transported with the sheet transportation unit 30 from becoming a load to the transportation of the sheet P at the secondary transfer section T2. As a result, when the color toner image is transferred to the sheet P at the secondary transfer section T2, it is possible to form an image without distortion, thereby improving image quality.

As described above, in the embodiment, the medium transportation control unit 72 and the medium transportation control unit 74 control the rotational speeds of the transportation motor 73 and the belt motor 75 such that the transportation speed of the sheet P at the sheet transportation unit 30 becomes higher than that of the sheet P at the secondary transfer section T2. More specifically, gears are disposed between the transportation motor 73 and the transportation roller pairs 32, 34, and 35. The gears have a specific number of teeth different from that of teeth of a gear disposed between the belt motor 75 and the drive roller 52. Accordingly, it is possible to make the transportation speed of the sheet P at the sheet transportation unit 30 higher than that of the sheet P at the secondary transfer section T2.

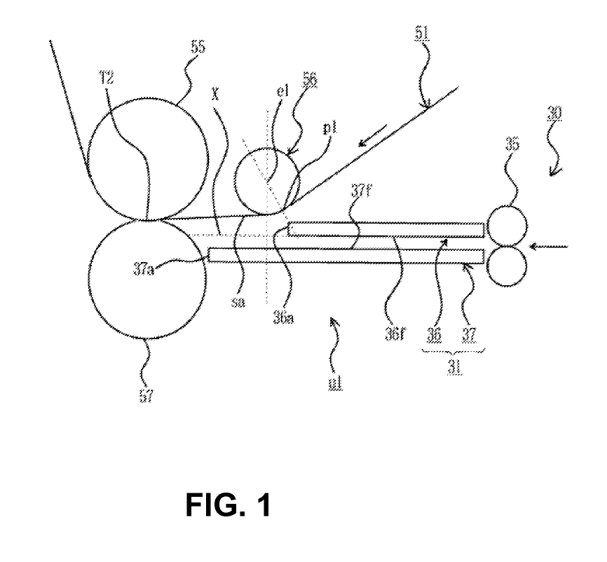

A transportation system u1 formed of the sheet transportation unit 30 and the secondary transfer section T2 will be explained next. FIG. 1 is a schematic view showing the transportation system u1 of the color printer according to the first embodiment of the present invention.

As shown in FIG. 1, the transportation system u1 includes the sheet transportation unit 30, the secondary transfer section T2, and a sheet guiding portion 31 as a medium guiding portion disposed between the sheet transportation unit 30 and the secondary transfer section T2 for guiding the sheet P (refer to FIG. 2) from the sheet transportation unit 30 to the secondary transfer section T2. The sheet guiding portion 31 is formed of the upper side guide member 36 and the lower side guide member 37. Further, the transportation system u1 includes the transportation roller pair 35, the back-up roller 55, the upper side guide member 36, and the secondary transfer roller 57.

In the embodiment, the back-up roller 55 is formed of a metal roller made of a metal such as aluminum, and is grounded to a frame ground formed of a chassis body of the color printer.

In the embodiment, the secondary transfer roller 57 includes a shaft portion made of a metal with electrical conductivity such as SUS and a rubber portion (a coating layer) formed of a rubber such as a urethane rubber for covering the shaft portion. Both end portions of the shaft portion are exposed, and the rubber portion is disposed to cover the shaft portion between the end portions. Accordingly, the rubber portion has a diameter larger than that of the shaft portion by a thickness of the rubber portion. Bearing portions are disposed on the end portions of the shaft portion, so that the bearing portions support the secondary transfer roller 57 to be freely rotatable. The rubber portion is formed of the urethane rubber containing a conductive agent such as carbon, pigment, and the like to have electrical conductivity. Accordingly, he rubber portion has a volume resistivity greater than 10² (Ω·cm) and less than 10⁸ (Ω·cm), for example, 10⁶ (Ω·cm).

In the embodiment, a power source device is connected to the shaft portion of the secondary transfer roller 57, so that the power source device applies a voltage greater than +1 kV and less than +5 kV, for example, +2 kV, to the secondary transfer roller 57. Accordingly, a potential difference is created between the secondary transfer roller 57 and the back-up roller 55, thereby forming an electrical field therebetween.

As described above, in the embodiment, the secondary transfer roller 57 is arranged to abut against the back-up roller 55 with the intermediate transfer belt 51 in between, so that the nip portion is formed in the contact area between the secondary transfer roller 57 and the back-up roller 55. In this case, the back-up roller 55 is formed of aluminum with relatively high rigidity, and the rubber portion of the secondary transfer roller 57 is formed of the urethane rubber with elasticity. Accordingly, the back-up roller 55 is pushed into the rubber portion of the secondary transfer roller 57 at the nip portion. As a result, a recess surface (a recess portion) is formed in a surface of the secondary transfer roller 57 such that the recess surface has a shape corresponding to that of a surface of the back-up roller 55 and a curvature radius equal to an outer diameter of the back-up roller 55. Accordingly, when the sheet P enters the secondary transfer section T2, the sheet P is curled along the recess surface, so that a portion of the sheet P near the secondary transfer section T2 is urged toward the back-up roller 55.

A configuration of the sheet guiding portion 31 will be explained in more detail next. As shown in FIG. 1, the upper side guide member 36 is arranged to face a printing surface of the sheet P, and the lower side guide member 37 is arranged to face a non-printing surface (opposite to the printing surface) of the sheet P. Further, the upper side guide member 36 and the lower side guide member 37 are formed of plastic plates and disposed between the transportation roller pair 35 and the secondary transfer section T2 for guiding the sheet P to the secondary transfer section T2.

More specifically, the lower side guide member 37 is arranged for supporting the sheet P between the transportation roller pair 35 and the secondary transfer section T2, and includes a guide portion 37f as a guide surface formed of a surface facing the upper side guide member 36. It is noted that the guide surface may be formed in various shapes such as a smooth surface, a rib, a groove, and the like.

In the embodiment, the lower side guide member 37 includes an end portion 37a on a downstream side in the transportation direction of the sheet P, and the end portion 37a is arranged to face the secondary transfer roller 57 near the secondary transfer roller 57. When the guide portion 37f extends toward the secondary transfer roller 57, an extended plane thereof crosses the surface of the secondary transfer roller 57. Accordingly, when the sheet P is transported such that the non-printing surface thereof contacts with the guide portion 37f, the sheet P is guided toward the secondary transfer roller 57. Further, a leading edge of the sheet P abuts against the secondary transfer roller 57.

In the embodiment, the upper side guide member 36 is arranged to cover the transportation path between the transportation roller pair 35 and the support roller 56. Further, the upper side guide member 36 includes an end portion 36a on a downstream side in the transportation direction of the sheet P, and the end portion 36a is arranged to face the secondary transfer roller 57 with a specific distance in between at an upstream side of the end portion 37a.

As shown in FIG. 1, the support roller 56 has a center point e1, and the support roller 56 starts contacting with the intermediate transfer belt 51 at a contact start point p1. The end portion 36a is situated at a position away from the center point e1 by a specific distance on the upstream side in the transportation direction of the sheet P. Further, the upper side guide member 36 crosses an extension line between the center point e1 and the contact start point p1 at the position of the end portion 36a. Accordingly, the end portion 36a is arranged to face the secondary transfer roller 57 with a specific distance in between, so that it is possible to place the sheet P to directly face the intermediate transfer belt 51 between the end portion 36a and the secondary transfer roller 57.

In the embodiment, the upper side guide member 36 further includes a guide portion 36f as a guide surface facing the lower side guide member 37. When the guide portion 36f extends toward the secondary transfer roller 57, an extended plane X thereof crosses the surface of the secondary transfer roller 57. Accordingly, the guide portion 36f is situated at a position below the secondary transfer section T2 in a vertical direction.

In the embodiment, the support roller 56 is formed of a metal roller made of a metal such as SUS, and is grounded to the ground frame. Further, the support roller 56 is arranged near the back-up roller 55 on an upstream side of the back-up roller 55 in the moving direction of the intermediate transfer belt 51, thereby bending the intermediate transfer belt 51 in a curved shape. Further, the intermediate transfer belt 51 extends near the transportation path of the sheet P in parallel to the transportation path between the back-up roller 55 and the support roller 56, thereby forming an area Sa facing the sheet P.

It is noted that, when the support roller 56 is not provided, the end portion 36a of the upper side guide member 36 is situated outside an area where the back-up roller 55 is disposed.

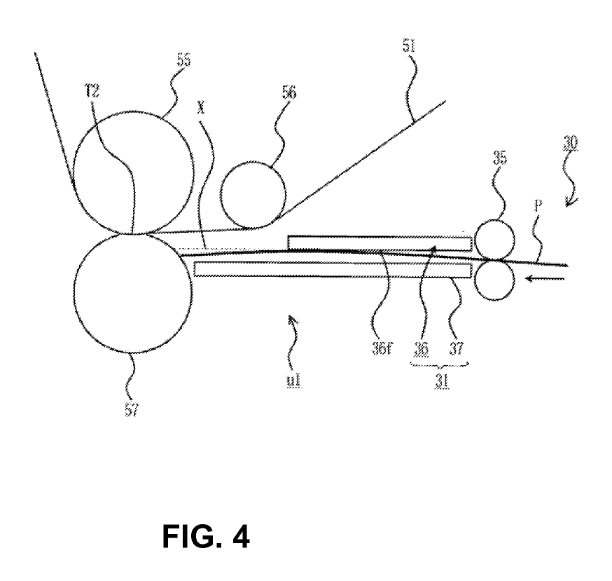

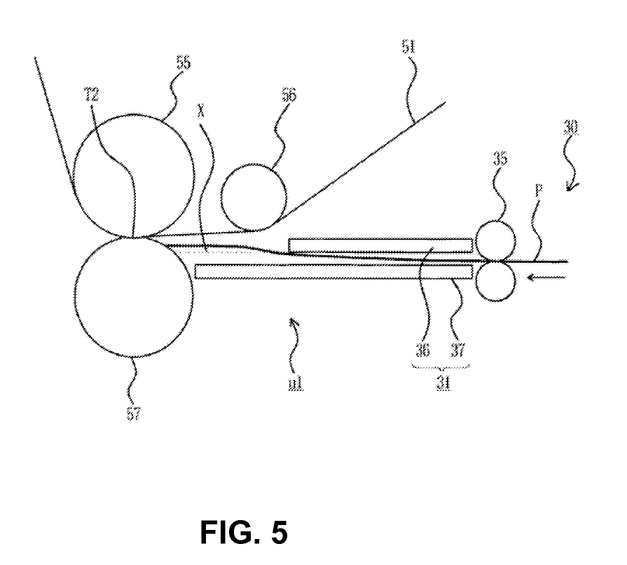

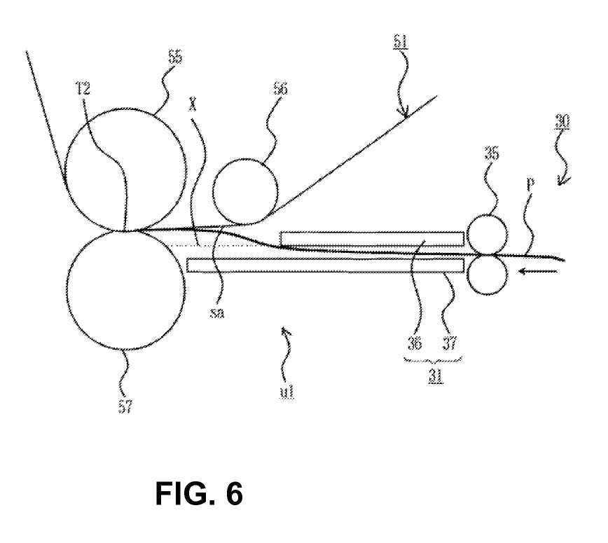

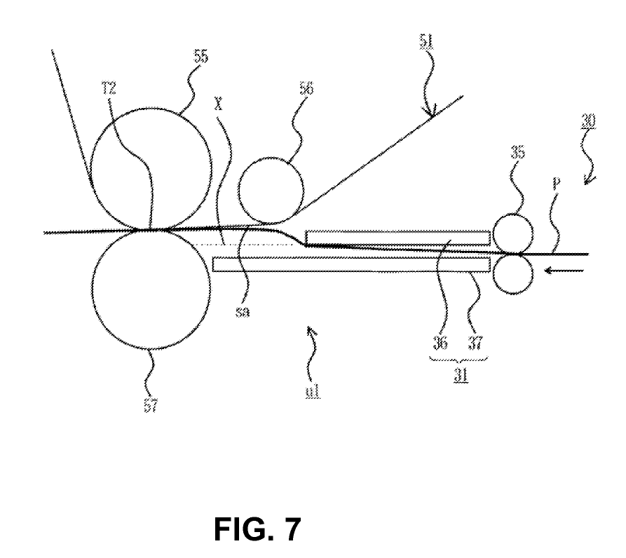

An operation of the transportation system u1 will be explained next. FIG. 4 is a schematic view No. 1 showing the operation of the transportation system u1 of the color printer according to the first embodiment of the present invention. FIG. 5 is a schematic view No. 2 showing the operation of the transportation system u1 of the color printer according to the first embodiment of the present invention. FIG. 6 is a schematic view No. 3 showing the operation of the transportation system u1 of the color printer according to the first embodiment of the present invention. FIG. 7 is a schematic view No. 4 showing the operation of the transportation system u1 of the color printer according to the first embodiment of the present invention.

In the embodiment, first, the transportation roller pair 35 transports the sheet P, and the sheet guiding portion 31 guides (supplies) the sheet P to the secondary transfer section T2. At this moment, the leading edge of the sheet P is regulated with the guide portions 36f and 37f formed on a side of the secondary transfer roller 57 in the area Sa. Accordingly, as shown in FIG. 4, the leading edge of the sheet P abuts against the secondary transfer roller 57.

At this moment, the secondary transfer roller 57 is rotating, so that the leading edge of the sheet P is moved upwardly toward the secondary transfer section T2 while abutting against the secondary transfer roller 57 as shown in FIG. 5. As described above, the transportation speed of the sheet P at the sheet transportation unit 30 is set to be greater than that of the sheet P at the secondary transfer section T2. Accordingly, the sheet P starts warping toward a direction where the printing surface thereof contacts with the upper side guide member 36.

In the next step, as shown in FIG. 6, the leading edge of the sheet P enters the secondary transfer section T2. At this moment, the sheet P warps to an extent larger than that in the state shown in FIG. 5. At a timing when the leading edge of the sheet P enters the secondary transfer section T2 or slightly after the timing, the printing surface of the sheet P contacts with the area Sa of the intermediate transfer belt 51.

In the next step, as shown in FIG. 7, when the sheet P is transported further, the sheet P warps to an extent larger than that in the state shown in FIG. 6. Accordingly, the printing surface of the sheet P contacts with the area Sa of the intermediate transfer belt 51 to a larger extent.

In the embodiment, when a trailing edge of the sheet P moves away from the transportation roller pair 35, the slack of the sheet P created by the difference in the transportation speeds disappears. At this moment, as described above, the sheet P warps along the recess surface at the secondary transfer section T2. Accordingly, the portion of the sheet P near the secondary transfer section T2 is urged toward the back-up roller 55. Accordingly, even after the trailing edge of the sheet P moves away from the transportation roller pair 35, it is possible to transport the sheet P while the printing surface of the sheet P contacts with the intermediate transfer belt 51.

As described above, in the embodiment, when the sheet P is transported while the non-printing surface thereof contacts with the guide portion 37f, and the leading edge of the sheet P abuts against the secondary transfer roller 57, the portion of the printing surface of the sheet P contacts with the area Sa of the intermediate transfer belt 51. Accordingly, it is possible to transport and enter the sheet P into the secondary transfer section T2 while the printing surface of the sheet P contacts with the intermediate transfer belt 51. As a result, even when the sheet P is transported and vibration is generated, it is possible to prevent the leading edge of the sheet P from deviating from the transportation direction of the sheet P. Accordingly, before the sheet P enters the secondary transfer section T2, it is possible to prevent the leading edge of the medium from abutting against the toner image on the intermediate transfer belt 51 before being fixed, thereby preventing the toner image from being distorted.

Further, in the embodiment, it is possible to smoothly transport the sheet P without a jam in the color printer or a winkle in the sheet P.

In the embodiment, the electrical filed generated between the secondary transfer roller 57 and the back-up roller 55 becomes weaker as being away from the secondary transfer section T2. Accordingly, the printing surface of the sheet P contacts with the intermediate transfer belt 51 at a position where the electrical field is relatively weak. As a result, toner of the toner image on the intermediate transfer belt 51 does not scatter before being fixed, thereby preventing the toner image from being distorted.

In the embodiment, when the sheet P is transported further in the secondary transfer section T2, the contact area between the printing surface of the sheet P and the area Sa of the intermediate transfer belt 51 increases as shown in FIG. 7. Accordingly, after the trailing edge of the sheet P is separated from the transportation roller pair 35, it is possible to transport the sheet P while the printing surface of the sheet P contacts with the intermediate transfer belt 51. As a result, it is possible to prevent the toner image from being distorted.

As described above, in the embodiment, the end portion 36a is situated on the upstream side of the contact start point p1 in the transportation direction of the sheet P. Accordingly, the trailing edge of the sheet P is separated from the upper side guide member 36 on the upstream side of the contact start point p1. Further, the intermediate transfer belt 51 is away from the transportation path of the sheet P on the upstream side of the contact start point p1. As a result, even when the trailing edge of the sheet P jumps off from the upper side guide member 36, the trailing edge of the sheet P does not abut against the intermediate transfer belt 51, thereby preventing the toner image from being distorted.

As described above, in the embodiment, it is possible to prevent the toner image from being distorted. Accordingly, it is possible to prevent the final image from being distorted (a blurred image), thereby improving image quality.

It is noted that if the end portion of the upper side guide member 36 on the downstream side is situated at a position on the upstream side of the end portion 36a, a length that the upper side guide member 36 guides the sheet P is shortened. Accordingly, it is not possible to efficiently guide the sheet P with the upper side guide member 36.

As described above, in the embodiment, the transportation speed of the sheet P at the sheet transportation unit 30 is set to be greater than that of the sheet P at the secondary transfer section T2, thereby warping the sheet P. When the difference between the transportation speed of the sheet P at the sheet transportation unit 30 and the transportation speed of the sheet P at the secondary transfer section T2 becomes excessively large, the warped portion of the sheet P may abut against the toner image on the intermediate transfer belt 51 before the leading edge of the sheet P enters the secondary transfer section T2.

To this end, in the embodiment, the difference between the transportation speed of the sheet P at the sheet transportation unit 30 and the transportation speed of the sheet P at the secondary transfer section T2 is set such that the warped portion of the sheet P does not abut against the toner image on the intermediate transfer belt 51 during the time from when the leading edge of the sheet P abuts against the secondary transfer roller 57 to when the leading edge of the sheet P enters the secondary transfer section T2. More specifically, the difference is set greater by 0.3% or smaller by 1.5% than the transportation speed of the sheet P at the secondary transfer section T2. The transportation speed of the sheet P tends to vary depending on characteristics and arrangements of the intermediate transfer belt 51, the back-up roller 55, and the secondary transfer roller 57. Accordingly, it is preferred that the transportation speed of the sheet P is individually set for each color printer.

As described above, in the embodiment, the lower side guide member 37 is disposed at the position closer to the secondary transfer roller 57 than the secondary transfer section T2, so that the leading edge of the sheet P abuts against the secondary transfer roller 57. Alternatively, an entire portion of the sheet guiding portion 31 may be arranged in an inclined state toward the back-up roller 55. Further, the end portions of the lower side guide member 37 and the upper side guide member 36 on the downstream side in the transportation direction of the sheet P may be partially curved toward the secondary transfer roller 57, so that the leading edge of the sheet P abuts against the secondary transfer roller 57.

### Second Embodiment

A second embodiment of the present invention will be explained next. Components in the second embodiment similar to those in the first embodiment are designated with the same reference numerals, and explanations thereof are omitted. The components in the second embodiment similar to those in the first embodiment provide similar effects.

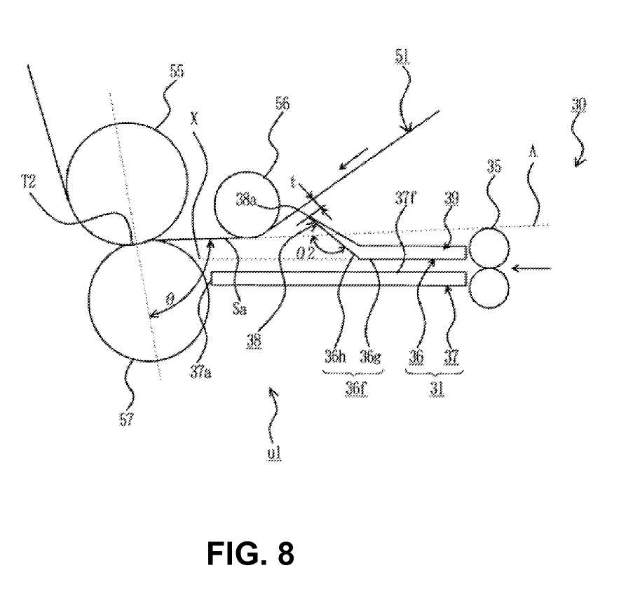

FIG. 8 is a schematic view showing the transportation system u1 of the color printer according to the second embodiment of the present invention.

As shown in FIG. 8, as compared with the first embodiment, the secondary transfer roller 57 as the second transfer member or the second transfer roller is arranged at a position further on the upstream side in the transportation direction of the sheet P. Similar to the first embodiment, the intermediate transfer belt 51 as the second image supporting member or the belt member includes the area Sa between the back-up roller 55 as the third roller and the support roller 56 as the fourth roller. In the transportation system u1, the secondary transfer roller 57 is further arranged such that a straight line between the center point of the secondary transfer roller 57 and the back-up roller 55 is inclined with respect to the area Sa by an angle θ less than 90°, i.e., an acute angle.

Accordingly, in the second embodiment, the intermediate transfer belt 51 covers a portion of the secondary transfer roller 57 slightly on the upstream side of the recess surface in the rotational direction thereof, so that the contact area between the secondary transfer roller 57 and the intermediate transfer belt 51 increases.

In the embodiment, when the sheet P enters the secondary transfer section T2 as the second transfer section formed of the intermediate transfer belt 51 and the secondary transfer roller 57, the printing surface of the sheet P is urged toward the intermediate transfer belt 51 due to the rigidity of the sheet P, so that the printing surface of the sheet P contacts with the intermediate transfer belt 51.

A configuration of the sheet guiding portion 31 as the medium guiding portion will be explained in more detail next. As shown in FIG. 8, the upper side guide member 36 as the first guide member includes the guide portion 36f as the guide surface facing the lower side guide member 37 as the second guide member. Further, the upper side guide member 36 includes a retracting portion 38 and a main body portion 39 extending in parallel to the lower side guide member 37. The retracting portion 38 extends in an inclined state from an end portion of the main body portion 39 on the downstream side in the transportation direction of the sheet P. That is, the retracting portion 38 is inclined from the transportation path toward the back-up roller 55 in a direction inclined relative to the guide portion 36f (the guide surface) and the transportation direction of the sheet P.

In the embodiment, the guide portion 36f includes a main body portion guide surface 36g as a first guide surface formed on the main body portion 39 and a retracting portion guide surface 36h as a second guide surface formed on the retracting portion 38.

In the embodiment, the retracting portion guide surface 36h is further arranged to be inclined with respect to the area Sa of the intermediate transfer belt 51 by an angle 2θ greater than 90°, i.e., an blunt angle, on a downstream side of the retracting portion 38 in the transportation direction of the sheet P. It is noted that the angle 2θ is determined by a distance between a distal end portion 38a of the retracting portion 38 and the transportation path of the sheet P, and a distance between the distal end portion and the secondary transfer roller 57 in the transportation direction of the sheet P.

In the embodiment, when the area Sa extends toward the sheet transportation unit 30, an extended plane A thereof crosses the retracting portion 38. The extended plane A contacts with the back-up roller 55 and the support roller 56, and extends in parallel to the transportation path of the sheet P. The distal end portion 38a is situated closer to the intermediate transfer belt 51 than the extended plane A.

In the embodiment, the distal end portion 38a is situated away from the intermediate transfer belt 51 by a specific distance t. It is preferable to set the specific distance t as small as possible to an extent that the retracting portion 38 does not contact with the intermediate transfer belt 51 even when the intermediate transfer belt 51 wobbles due to vibrations of the intermediate transfer belt 51. For example, the intermediate transfer belt 51 typically wobbles by about 1 mm, due to vibrations of the intermediate transfer belt 51, so that the specific distance t may be set greater than 1 mm and smaller than 2 mm. The distal end portion 38a of the retracting portion 38 is formed in a sharp-pointed shape, thereby making it possible to accurately set the specific distance t.

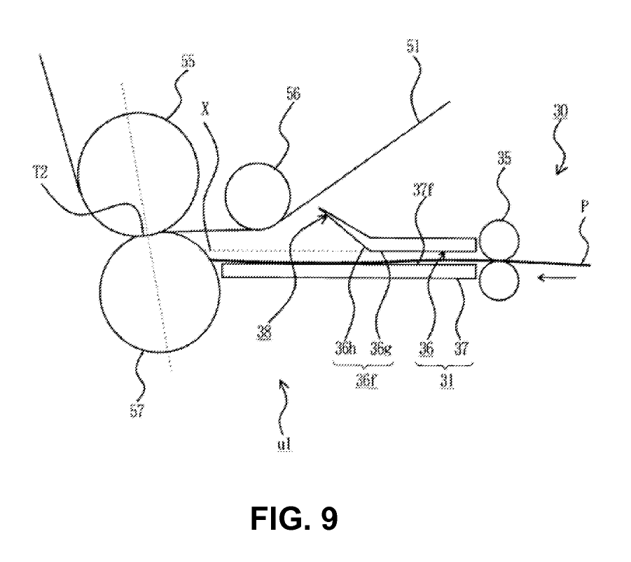

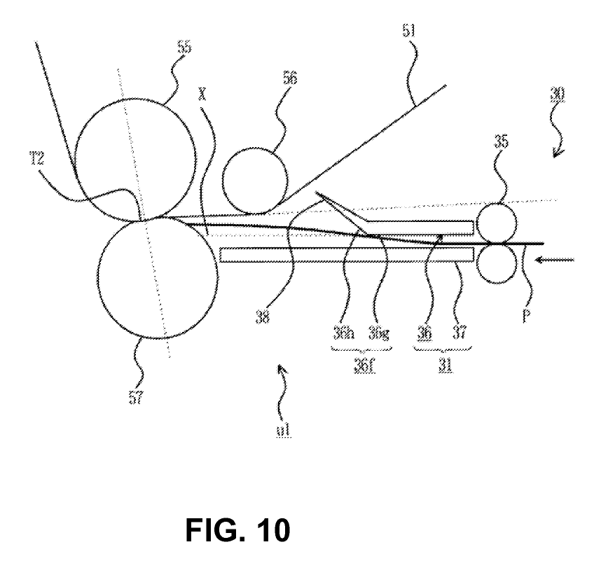

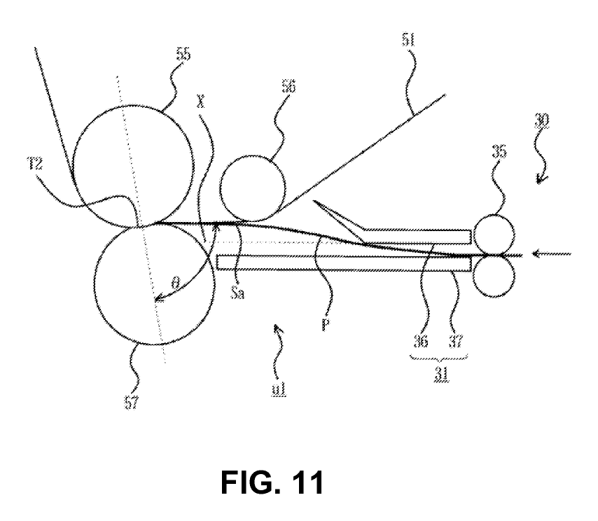

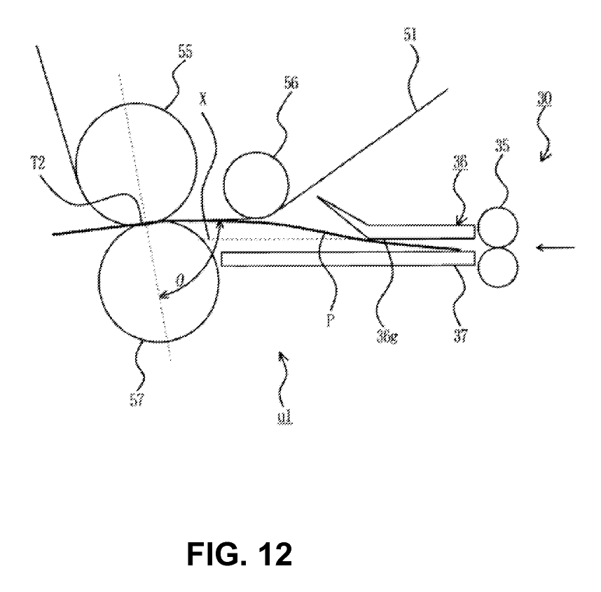

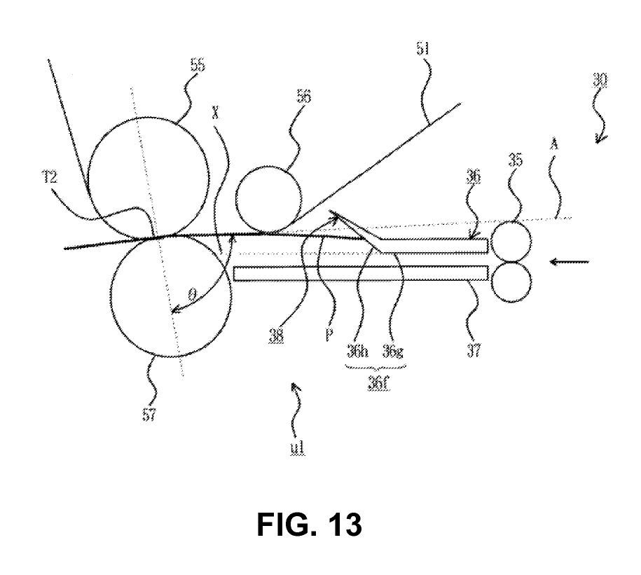

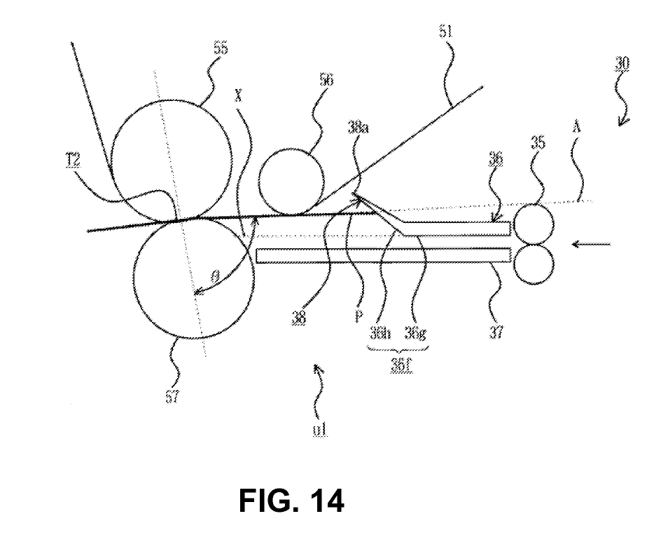

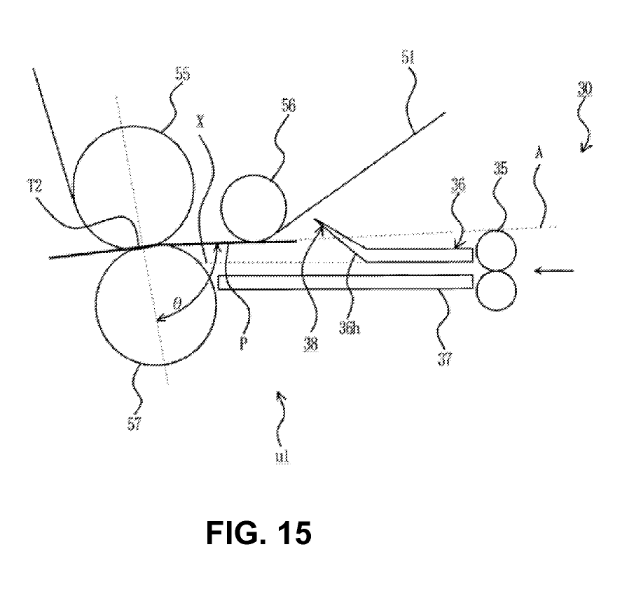

An operation of the transportation system u1 will be explained next. FIG. 9 is a schematic view No. 1 showing the operation of the transportation system u1 of the color printer according to the second embodiment of the present invention. FIG. 10 is a schematic view No. 2 showing the operation of the transportation system u1 of the color printer according to the second embodiment of the present invention. FIG. 11 is a schematic view No. 3 showing the operation of the transportation system u1 of the color printer according to the second embodiment of the present invention. FIG. 12 is a schematic view No. 4 showing the operation of the transportation system u1 of the color printer according to the second embodiment of the present invention. FIG. 13 is a schematic view No. 5 showing the operation of the transportation system u1 of the color printer according to the second embodiment of the present invention. FIG. 14 is a schematic view No. 6 showing the operation of the transportation system u1 of the color printer according to the second embodiment of the present invention. FIG. 15 is a schematic view No. 7 showing the operation of the transportation system u1 of the color printer according to the second embodiment of the present invention.

In the embodiment, first, the transportation roller pair 35 as the first transportation component transports the sheet P, and the sheet guiding portion 31 guides the sheet P to the secondary transfer section T2. At this moment, the leading edge of the sheet P is regulated with the guide portions 36f and 37f. Accordingly, as shown in FIG. 9, the leading edge of the sheet P abuts against the secondary transfer roller 57.

At this moment, the secondary transfer roller 57 is rotating, so that the leading edge of the sheet P is moved upwardly toward the secondary transfer section T2 while abutting against the secondary transfer roller 57 as shown in FIG. 10. Accordingly, the sheet P is warped and a specific portion of the sheet P abuts against a distal end portion of the main body portion guide surface 36g.

In the next step, as shown in FIG. 11, the leading edge of the sheet P enters the secondary transfer section T2. As described above, the secondary transfer roller 57 is arranged such that the straight line between the center point of the secondary transfer roller 57 and the back-up roller 55 is inclined with respect to the area Sa by the angle θ less than 90°, i.e., an acute angle. Further, the intermediate transfer belt 51 is arranged to cover the secondary transfer roller 57 near the secondary transfer section T2. Accordingly, the sheet P is curved along the outer circumferential surface of the secondary transfer roller 57 while being transported. At this moment, the sheet P is urged in a direction to remove the curved state due to the rigidity of the sheet P, so that the portion of the sheet P on the upstream side of the secondary transfer section T2 is urged toward the intermediate transfer belt 51, thereby warping the sheet P. Accordingly, the printing surface of the sheet P contacts with the area Sa of the intermediate transfer belt 51.

In the next step, as shown in FIG. 12, when the trailing edge of the sheet P passes through the transportation roller pair 35, since the portion of the sheet P on the upstream side of the secondary transfer section T2 is urged toward the intermediate transfer belt 51, the sheet P is transported while the specific portion thereof abuts against the distal end portion of the main body portion guide surface 36g.

In the next step, as shown in FIG. 13, when the trailing edge of the sheet P passes through the distal end portion of the main body portion guide surface 36g, the sheet P is transported while the trailing edge thereof contacts with the retracting portion guide surface 36h of the retracting portion 38. In this state, a specific load is applied to the trailing edge of the sheet P in the vertical direction due to friction between the trailing edge and the retracting portion guide surface 36h. More specifically, the retracting portion guide surface 36h functions as a damper relative to the sheet P through the specific load.

In the next step, as shown in FIGS. 14 and 15, when the trailing edge of the sheet P reaches before a crossing point of the retracting portion 38 and the extended plane A, the trailing edge of the sheet P moves away from the retracting portion guide surface 36h. At this moment, since the specific load is applied to the trailing edge of the sheet P in the vertical direction just before, the sheet P does not wobble when the trailing edge of the sheet P moves away from the retracting portion guide surface 36h. Afterward, while the secondary transfer roller 57 rotates, the sheet P is transported further, so that the trailing edge of the sheet P moves on the extended plane A.

As described above, in the embodiment, when the leading edge of the sheet P enters the secondary transfer section T2, the portion of the sheet P on the upstream side of the secondary transfer section T2 is urged toward the intermediate transfer belt 51, so that the printing surface of the sheet P contacts with the intermediate transfer belt 51. Accordingly, it is possible to transport the sheet P while the printing surface of the sheet P contacts with the intermediate transfer belt 51, thereby preventing the toner image as the developer image from being distorted.

Further, in the embodiment, the sheet P is transported while the printing surface of the sheet P contacts with the intermediate transfer belt 51. Accordingly, the trailing edge of the sheet P is moved while contacting with the retracting portion guide surface 36h of the retracting portion 38. Accordingly, when the trailing edge moves away from the retracting portion guide surface 36h, the sheet P does not wobble or vibrate. As a result, it is possible to prevent the trailing edge of the sheet P from abutting against the toner image on the intermediate transfer belt 51, thereby making it possible to prevent the toner image from being distorted.

As described above, in the embodiment, it is possible to prevent the toner image from being distorted. Accordingly, it is possible to prevent the resultant image from being distorted, thereby improving image quality. Further, it is possible to prevent the trailing edge of the sheet P from hopping up, thereby preventing a hopping noise.

Further, in the second embodiment, the intermediate transfer belt 51 is arranged to cover the secondary transfer roller 57 near the secondary transfer section T2. Accordingly, the portion of the sheet P on the upstream side of the secondary transfer section T2 is urged toward the intermediate transfer belt 51. Accordingly, when the transportation speed of the sheet P at the sheet transportation unit 30 is set not to be higher than the transportation speed of the sheet P at the secondary transfer section T2 like in the first embodiment, it is possible to form the slack of the sheet P between the sheet transportation unit 30 and the secondary transfer section T2, thereby making it possible to contact the printing surface of the sheet P with the area Sa of the intermediate transfer belt 51.

Accordingly, it is possible to reduce the difference in the transportation speeds of the transportation roller pair 35 and the secondary transfer section T2, or even possible to make the difference zero. It is noted that when the transportation speed of the sheet P at the sheet transportation unit 30 becomes lower than the transportation speed of the sheet P at the secondary transfer section T2 due to a production variance or a assembly variance of the components, the transportation of the sheet P at the sheet transportation unit 30 becomes a load relative to the transportation of the sheet P at the secondary transfer section T2. Accordingly, it is preferred that the transportation speed of the sheet P at the sheet transportation unit 30 is set higher by 0.1% and lower by 0.2% than the transportation speed of the sheet P at the secondary transfer section T2.

### Third Embodiment

A third embodiment of the present invention will be explained next. Components in the third embodiment similar to those in the first and second embodiments are designated with the same reference numerals, and explanations thereof are omitted. The components in the third embodiment similar to those in the first and second embodiments provide similar effects.

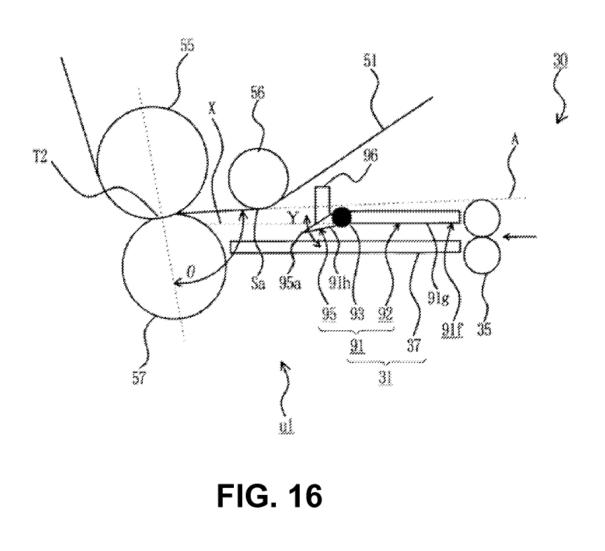

FIG. 16 is a schematic view showing the transportation system u1 of the color printer according to the third embodiment of the present invention.

As shown in FIG. 16, the sheet guiding portion 31 as the medium guiding portion includes an upper side guide member 91 as the first guide member and the lower side guide member 37 as the second guide member.

In the embodiment, the upper side guide member 91 includes a guide portion 91f as a guide surface facing the lower side guide member 37. Further, the upper side guide member 91 includes a main body portion 92; a retracting portion 95 arranged to be freely rotatable at an end portion of the main body portion 92 in the transportation direction of the sheet P; a hinge 93 as a supporting member for supporting the retracting portion 95; and a spring 96 as an urging member.

In the embodiment, the spring 96 is arranged such that one end portion thereof abuts against the retracting portion 95 and the other end portion thereof abuts against a spring receiving portion (not shown) as a specific fixing portion in the color printer, thereby urging the retracting portion 95 toward the lower side guide member 37. The guide portion 91f includes a main body portion guide surface 91g as a first guide surface formed on the main body portion 92 and a retracting portion guide surface 91h as a second guide surface formed on the retracting portion 95. An extended plane X of the upper side guide member 91 crosses the secondary transfer roller 57 on the downstream side in the transportation direction of the sheet P.

In the embodiment, the upper side guide member 91, the main body portion 92, and the retracting portion 95 are formed of a plastic, and have a smooth surface contacting with the sheet P.

In the embodiment, a distal end portion 95a of the retracting portion 95 is selectively switched relative to the extended plane A between a side of the secondary transfer roller 57 as the second transfer member or the second transfer roller and a side of the back-up roller 55 as the third roller. More specifically, when the retracting portion 95 is moved obliquely downward (toward the lower side guide member 37) with an urging force of the spring 96, the distal end portion 95a of the retracting portion 95 is situated below the extended planes A and X. When the retracting portion 95 is moved obliquely upward (toward the intermediate transfer belt 51) against the urging force of the spring 96, the distal end portion 95a of the retracting portion 95 is situated above the extended planes A and X.

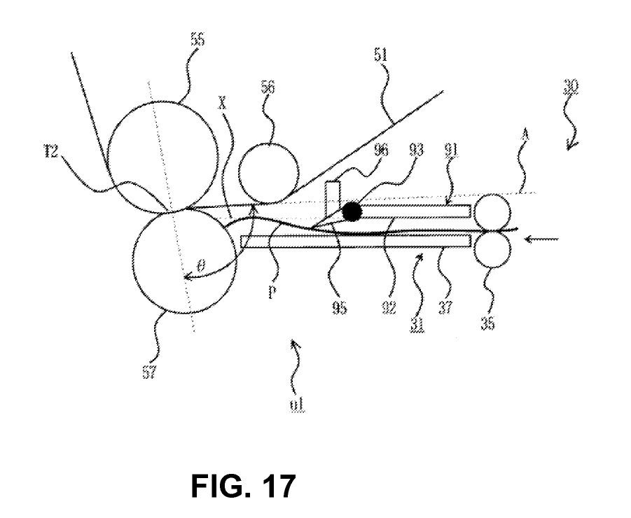

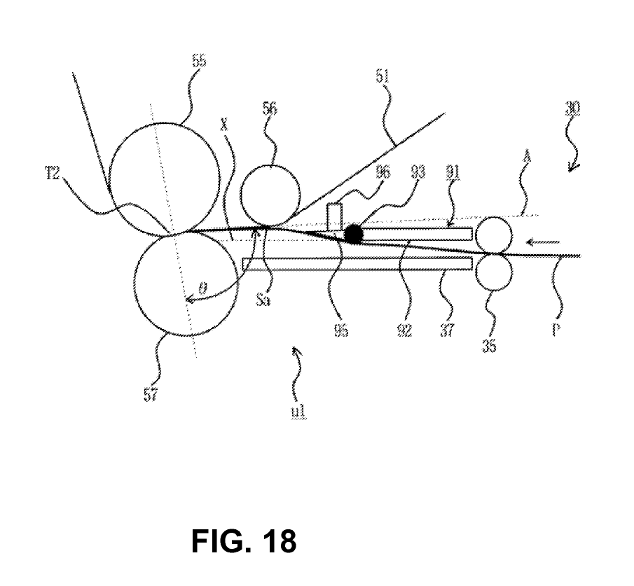

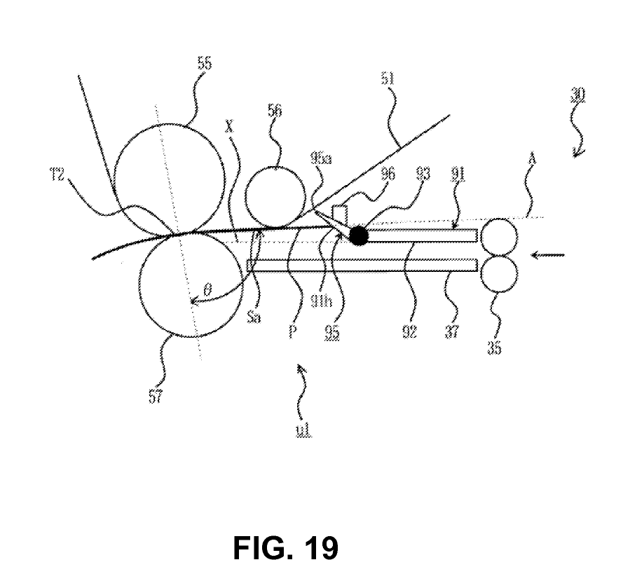

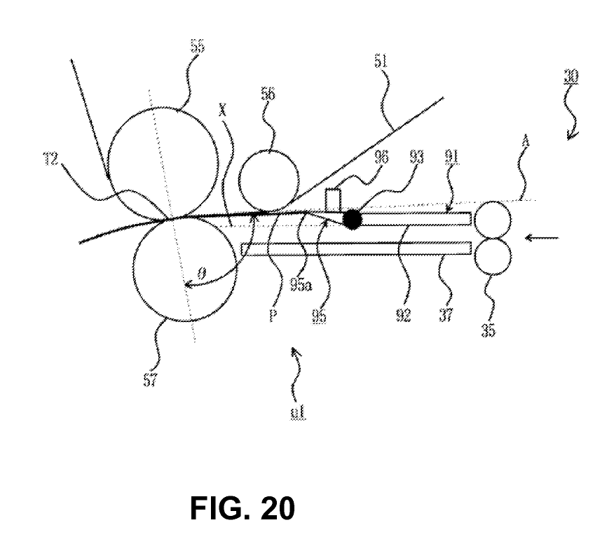

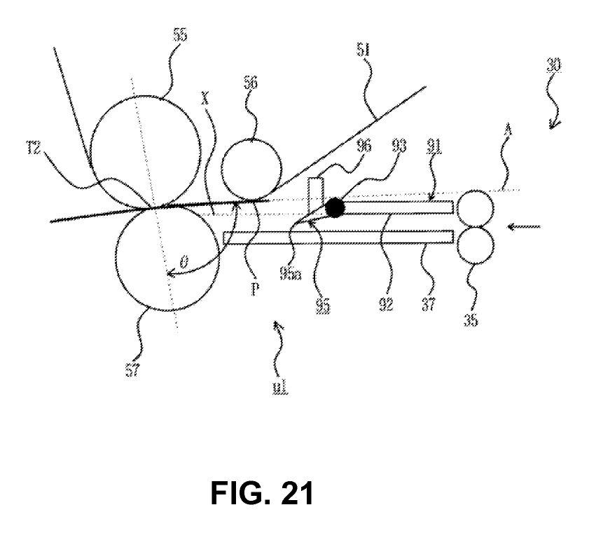

An operation of the transportation system u1 will be explained next. FIG. 17 is a schematic view No. 1 showing the operation of the transportation system u1 of the color printer according to the third embodiment of the present invention. FIG. 18 is a schematic view No. 2 showing the operation of the transportation system u1 of the color printer according to the third embodiment of the present invention. FIG. 19 is a schematic view No. 3 showing the operation of the transportation system u1 of the color printer according to the third embodiment of the present invention. FIG. 20 is a schematic view No. 4 showing the operation of the transportation system u1 of the color printer according to the third embodiment of the present invention. FIG. 21 is a schematic view No. 5 showing the operation of the transportation system u1 of the color printer according to the third embodiment of the present invention.

In the embodiment, first, the transportation roller pair 35 transports the sheet P, and the sheet guiding portion 31 guides the sheet P to the secondary transfer section T2 as the second transfer section. When the leading edge of the sheet P passes through the main body portion 92, the retracting portion 95 guides the leading edge of the sheet P. At this moment, as shown in FIG. 17, the spring 96 urges the retracting portion 95 to move obliquely downward. Accordingly, after the retracting portion 95 guides the sheet P toward the lower side guide member 37, the sheet P is transported along the lower side guide member 37, so that the leading edge of the sheet P abuts against the secondary transfer roller 57.

At this moment, the secondary transfer roller 57 is rotating, so that the leading edge of the sheet P is moved upwardly toward the secondary transfer section T2 while abutting against the secondary transfer roller 57. Accordingly, the sheet P is warped.

In the next step, as shown in FIG. 18, the leading edge of the sheet P enters the secondary transfer section T2. As described above, the secondary transfer roller 57 is arranged such that the straight line between the center point of the secondary transfer roller 57 and the back-up roller 55 is inclined with respect to the area Sa by the angle θ less than 90°, i.e., an acute angle. Further, the intermediate transfer belt 51 is arranged to cover the secondary transfer roller 57 near the secondary transfer section T2. Accordingly, the sheet P is curved along the outer circumferential surface of the secondary transfer roller 57 while being transported. At this moment, the sheet P is urged in a direction to remove the curved state due to the rigidity of the sheet P, so that the portion of the sheet P on the upstream side of the secondary transfer section T2 is urged toward the intermediate transfer belt 51, thereby warping the sheet P. Accordingly, the printing surface of the sheet P contacts with the area Sa of the intermediate transfer belt 51.

At this moment, the sheet P pushes the retracting portion 95 upwardly. Accordingly, the retracting portion 95 rotates in a clockwise direction in FIG. 18 against the urging force of the spring 96, and stops at a position where the upward force is balanced with the urging force.

In the next step, when the trailing edge of the sheet P reaches the retracting portion 95, the restoration force of the sheet P is applied to the retracting portion 95. Accordingly, the retracting portion 95 rotates further in the clockwise direction in FIG. 18, and is moved obliquely upward as shown in FIG. 19. As a result, the sheet P is transported along the extended plane A of the area Sa while the trailing edge of the sheet P contacts with the retracting portion guide surface 91h.

In the next step, the retracting portion 95 rotates in a counterclockwise direction in FIG. 19 with the urging force of the spring 96. In this state, a specific load is applied to the trailing edge of the sheet P in the vertical direction due to friction between the trailing edge and the retracting portion guide surface 91h. More specifically, the retracting portion guide surface 91h functions as a damper relative to the sheet P through the specific load. It is noted that, in this state, the distal end portion 95a of the retracting portion 95 is situated on the side of the intermediate transfer belt 51 relative to the extended plane A.

In the next step, as shown in FIG. 20, when the sheet P is transported further, the trailing edge of the sheet P reaches the distal end portion 95a of the retracting portion 95. Accordingly, the trailing edge of the sheet P is situated on the extended plane A, and the distal end portion 95a of the retracting portion 95 is situated on the extended plane A.

In the next step, as shown in FIG. 21, when the trailing edge of the sheet P moves away from the retracting portion 95, the retracting portion 95 is moved obliquely downward with the urging force of the spring, so that the distal end portion 95a of the retracting portion 95 is situated below the extended plane A.

When the color printer performs a duplex printing operation to print on a front surface and a backside surface of the sheet P, the sheet P tends to be curled when the backside surface of the sheet P is printed. As described above, in the embodiment, it is possible to transport the sheet P along the lower side guide member 37 until the leading edge of the sheet P abuts against the secondary transfer roller 57. Accordingly, even when the sheet P tends to be curled, it is possible to prevent the sheet P from being curled. As a result, before the sheet P enters the secondary transfer section T2, it is possible to prevent the leading edge of the sheet P from abutting against the toner image on the intermediate transfer belt 51 before being fixed, thereby preventing the toner image from being distorted. Therefore, it is possible to prevent the image from being distorted, thereby improving image quality.

### Fourth Embodiment

A fourth embodiment of the present invention will be explained next. Components in the fourth embodiment similar to those in the first to third embodiments are designated with the same reference numerals, and explanations thereof are omitted. The components in the fourth embodiment similar to those in the first to third embodiments provide similar effects.

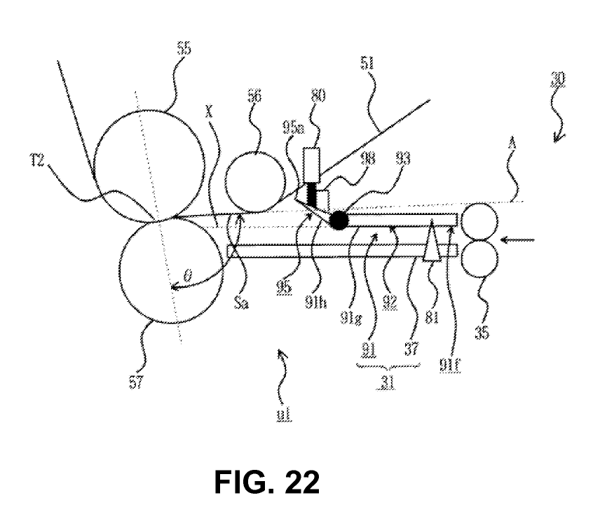

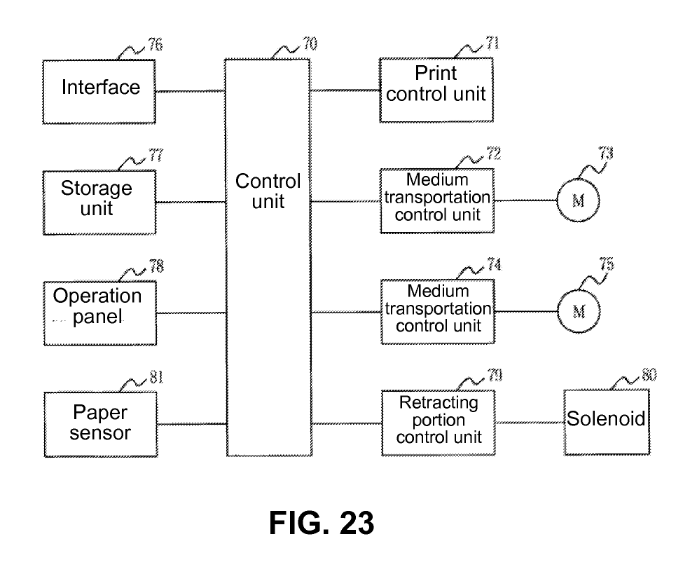

FIG. 22 is a schematic view showing a transportation system u1 of a color printer according to the fourth embodiment of the present invention. FIG. 23 is a block diagram showing a control system of the color printer according to the fourth embodiment of the present invention.

As shown in FIG. 22, a paper sensor 81 of a non-contact type (an optical type) as a medium detection unit is provided for detecting the leading edge of the sheet P. The paper sensor 81 is disposed on the downstream side of the transportation roller pair 35 as the first transportation element and on the upstream side of the retracting portion 95 in the transportation direction of the sheet P as the medium. Further, the paper sensor 81 is connected to the control unit 70.

In the embodiment, a medium determination processing unit (not shown) is provided in the control unit 70 for performing a medium determination process. When the medium determination processing unit receives a sensor output from the paper sensor 81, the medium determination processing unit determines that the sheet P passes through the transportation roller pair 35. It is noted that the paper sensor 81 may be formed of a contact type sensor.

In the embodiment, the upper side guide member 91 as the first guide member includes the main body portion 92; the retracting portion 95 arranged to be freely rotatable at the end portion of the main body portion 92 in the transportation direction of the sheet P; the hinge 93 as the supporting member for supporting the retracting portion 95; a spring 98 as an urging member; and a solenoid 80 of a push type as a drive unit for rotating the retracting portion 95.

In the embodiment, the spring 98 is arranged such that one end portion thereof engaging the retracting portion 95 and the other end portion thereof engaging a spring receiving portion (not shown) as a specific fixing portion in the color printer, thereby urging the retracting portion 95 toward the intermediate transfer belt 51 as the belt member and the second image supporting member.

In the embodiment, a retracting portion control unit 79 is provided, so that the solenoid 80 is connected to the control unit 70 through the retracting portion control unit 79. A retracting portion control processing unit (not shown) is provided in the control unit 70 for performing a retracting portion control process. When the retracting portion control processing unit receives the sensor output from the paper sensor 81, the retracting portion control processing unit turns off or on (drives) the solenoid 80.

In the embodiment, when the solenoid 80 is turned on, the solenoid 80 rotates the retracting portion 95 in the counterclockwise direction against the urging force of the spring 98, so that the retracting portion 95 is moved obliquely downward (toward the lower side guide member 37), and the distal end portion 95a of the retracting portion 95 is situated below the extended plane X. When the solenoid 80 is turned off, the retracting portion 95 rotates in the clockwise direction with the urging force of the spring 98, so that the retracting portion 95 is moved obliquely upward (toward the intermediate transfer belt 51), and the distal end portion 95a of the retracting portion 95 is situated above the extended plane A.

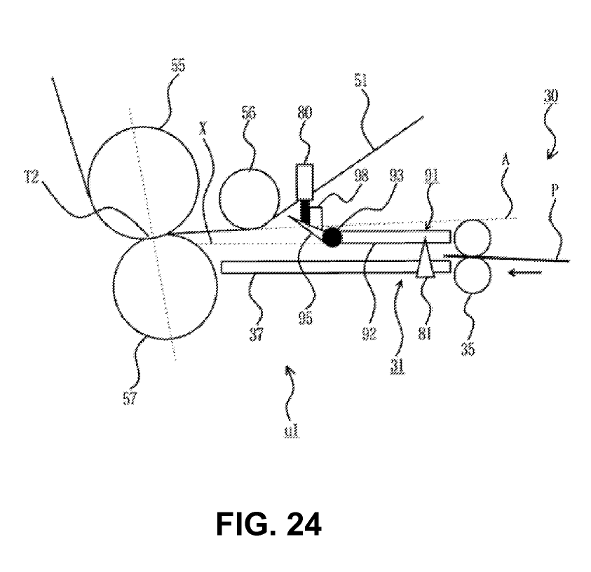

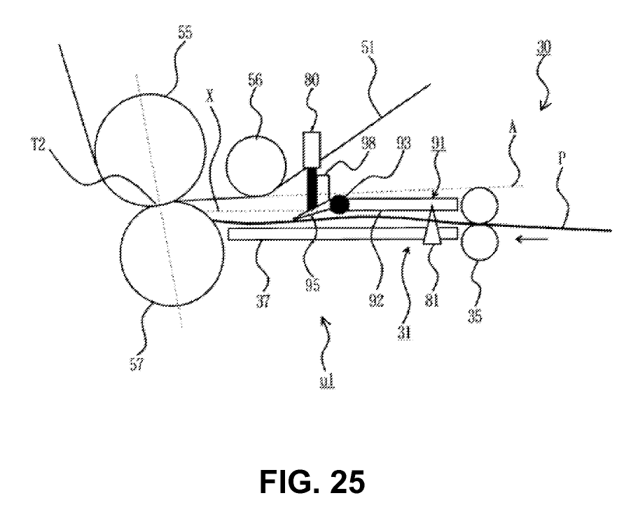

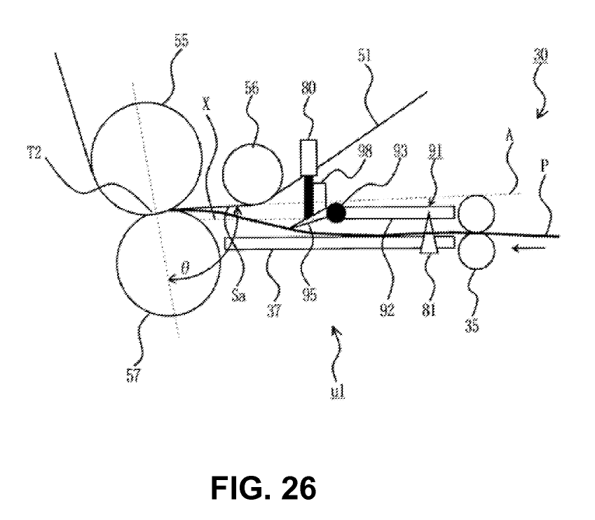

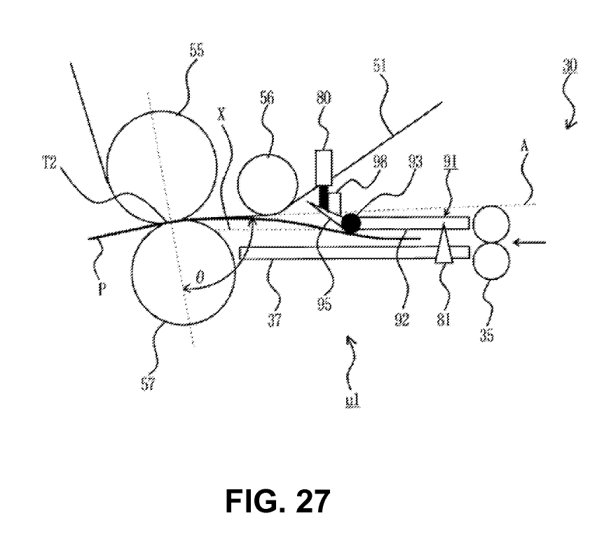

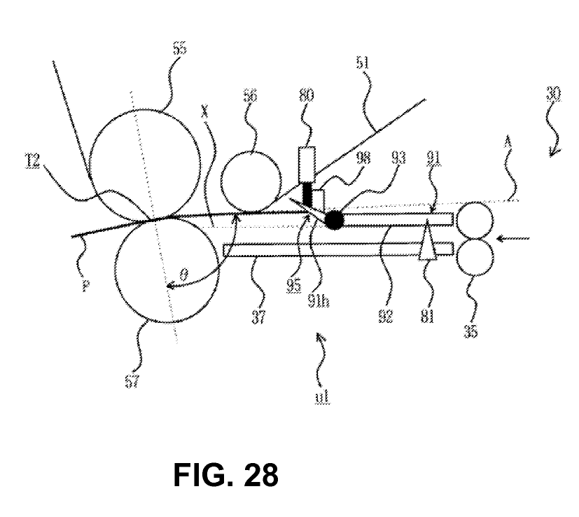

An operation of the transportation system u1 will be explained next. FIG. 24 is a schematic view No. 1 showing the operation of the transportation system u1 of the color printer according to the fourth embodiment of the present invention. FIG. 25 is a schematic view No. 2 showing the operation of the transportation system u1 of the color printer according to the fourth embodiment of the present invention. FIG. 26 is a schematic view No. 3 showing the operation of the transportation system u1 of the color printer according to the fourth embodiment of the present invention. FIG. 27 is a schematic view No. 4 showing the operation of the transportation system u1 of the color printer according to the fourth embodiment of the present invention. FIG. 28 is a schematic view No. 5 showing the operation of the transportation system u1 of the color printer according to the fourth embodiment of the present invention.

In the embodiment, first, the transportation roller pair 35 transports the sheet P, and the sheet guiding portion 31 guides the sheet P. In this state, as shown in FIG. 24, before the leading edge of the sheet P reaches the paper sensor 81, the solenoid 80 is turned off, and the retracting portion 95 is inclined obliquely upward.

When the leading edge of the sheet P reaches the paper sensor 81, the paper sensor 81 detects the leading edge of the sheet P, so that the sensor output of the paper sensor 81 is sent to the control unit 70. When the medium determination processing unit receives the sensor output from the paper sensor 81, the medium determination processing unit determines that the sheet P passes through the transportation roller pair 35. Accordingly, the retracting portion control processing unit turns on the solenoid 80, so that the solenoid 80 moves the retracting portion 95 obliquely downward. It is noted that the paper sensor 81 continues sending the sensor output to the control unit 70 until the trailing edge of the sheet P passes through the paper sensor 81. Accordingly, the retracting portion control processing unit maintains the on-state of the solenoid 80, so that the solenoid 80 maintains the retracting portion 95 obliquely downward.

In the next step, as shown in FIG. 25, the sheet P is transported along the lower side guide member 37, so that the leading edge of the sheet P abuts against the secondary transfer roller 57 as the second transfer member or the second transfer roller.

At this moment, the secondary transfer roller 57 is rotating, so that the leading edge of the sheet P is moved upwardly toward the secondary transfer section T2 as the second transfer portion while abutting against the secondary transfer roller 57. Accordingly, the sheet P is warped.

In the next step, as shown in FIG. 26, the leading edge of the sheet P enters the secondary transfer section T2. As described above, the secondary transfer roller 57 is arranged such that the straight line between the center point of the secondary transfer roller 57 and the back-up roller 55 is inclined with respect to the area Sa by the angle θ less than 90°, i.e., an acute angle. Further, the intermediate transfer belt 51 is arranged to cover the secondary transfer roller 57. Accordingly, the sheet P is curved along the outer circumferential surface of the secondary transfer roller 57 while being transported. At this moment, the sheet P is urged in the direction to remove the curved state due to the rigidity of the sheet P, so that the portion of the sheet P on the upstream side of the secondary transfer section T2 is urged toward the intermediate transfer belt 51, thereby warping the sheet P. Accordingly, the printing surface of the sheet P contacts with the area Sa of the intermediate transfer belt 51.

In the next step, as shown in FIG. 27, when the trailing edge of the sheet P passes through the paper sensor 81, the retracting portion control processing unit turns off the solenoid 80, so that the retracting portion 95 moves obliquely upward.

In the next step, as shown in FIG. 28, when the trailing edge of the sheet P reaches the retracting portion 95, the sheet P is transported while the trailing edge of the sheet P contacts with the retracting portion guide surface 91h as the second guide surface. In this state, a specific load is applied to the trailing edge of the sheet P in the vertical direction due to friction between the trailing edge and the retracting portion guide surface 91h. More specifically, the retracting portion guide surface 91h functions as a damper relative to the sheet P through the specific load.

In the next step, when the trailing edge of the sheet P reaches before the crossing point of the retracting portion 95 and the extended plane A, the trailing edge of the sheet P moves away from the retracting portion guide surface 91h. At this moment, since the specific load is applied to the trailing edge of the sheet P in the vertical direction just before, the sheet P does not wobble when the trailing edge of the sheet P moves away from the retracting portion guide surface 91h. Afterward, while the secondary transfer roller 57 rotates, the sheet P is transported further, so that the trailing edge of the sheet P moves on the extended plane A.

As described above, in the embodiment, when the solenoid 80 is turned on, the retracting portion 95 is moved obliquely downward. Accordingly, the leading edge of the sheet P abuts against the secondary transfer roller 57, thereby guiding the sheet P toward the secondary transfer section T2. As a result, it is possible to urge the portion of the sheet P on the upstream side of the secondary transfer section T2 toward the intermediate transfer belt 51, and to contact the printing surface of the sheet P with the area Sa of the intermediate transfer belt 51. Therefore, it is possible to prevent a jam in the color printer or a winkle in the sheet P, thereby smoothly transporting the sheet P.

Further, in the embodiment, when the solenoid 80 is turned off, the retracting portion 95 moves obliquely upward. Accordingly, it is possible to transport the sheet P while the trailing edge of the sheet P contacts with the retracting portion guide surface 91h. Accordingly, the sheet P does not wobble when the trailing edge of the sheet P moves away from the retracting portion guide surface 91h. As a result, it is possible to prevent the trailing edge of the sheet P from abutting against the toner image on the intermediate transfer belt 51 before being fixed. Therefore, it is possible to prevent the toner image from being distorted, thereby preventing the image from being distorted and improving image quality.

Further, in the embodiment, it is possible to move obliquely downward or upward through turning on or off the solenoid 80. Accordingly, even when the sheet P is a thick cardboard with high rigidity or a sheet with propensity of curling, it is possible to properly control the leading edge and the trailing edge of the sheet P. As a result, it is possible to prevent the leading edge and the trailing edge of the sheet P from abutting against the toner image on the intermediate transfer belt 51 before being fixed. Therefore, it is possible to prevent the toner image from being distorted, thereby preventing the image from being distorted and improving image quality.

In the embodiments described above, the color printer of the electro-photography type is explained as the image forming apparatus. The present invention may be applicable to an image forming apparatus such as a facsimile, a copier, and a multi function peripheral or product (MFP).

The disclosure of Japanese Patent Application No. 2009-233036, filed on Oct. 7, 2009, is incorporated in the application.

While the invention has been explained with reference to the specific embodiments of the invention, the explanation is illustrative and the invention is limited only by the appended claims.

What is claimed is:

1. An image forming apparatus comprising:
a first transportation unit for transporting a medium;
a second transportation unit for transporting the sheet supplied from the first transportation unit, said second transportation unit including a first transportation member and a second transportation member disposed on both sides of a transportation path of the medium on a downstream side of the first transportation unit in a transportation direction of the medium; and
a medium guiding portion disposed between the first transportation unit and the second transportation unit for guiding the medium supplied from the first transportation unit toward the second transportation unit, said medium guiding portion including a guide surface facing the transportation path for guiding the medium toward the first transportation member of the second transportation unit.

2. The image forming apparatus according to claim 1, wherein said guide surface is disposed at a position closer to the first transportation member than the transportation path in a direction away from the transportation path.

3. The image forming apparatus according to claim 1, wherein said second transportation unit further includes an image supporting member so that an image on the image supporting member is transferred to the medium.

4. The image forming apparatus according to claim 1, wherein said medium guiding portion further includes a first guide member having the guide surface and a second guide member disposed at a position closer to the second transportation member than the first guide member, said first guide member having a first end portion on a downstream side in the transportation direction, said second guide member having a second end portion on the downstream side in the transportation direction, said second end portion being situated on an upstream side of the first end portion in the transportation direction.

5. The image forming apparatus according to claim 1, wherein said first transportation unit is arranged to transport the medium at a transportation speed higher than that of the second transportation unit.

6. The image forming apparatus according to claim 1, wherein said second transportation unit further includes a belt member sandwiched with the first transportation member and the second transportation member.

7. The image forming apparatus according to claim 1, wherein said second transportation member is disposed at a plurality of positions.

8. The image forming apparatus according to claim 1, wherein said second transportation unit further includes a belt member extended with the second transportation member so that the first transportation member is pressed against the second transportation member with the belt member in between.

9. The image forming apparatus according to claim 1, wherein said medium guiding portion further includes a main body portion and a retracting portion disposed on a downstream side of the main body portion in the transportation direction.

10. The image forming apparatus according to claim 9, wherein said retracting portion is arranged to extend from an end portion of the main body portion toward the second transportation member in a direction away from the transportation path.

11. The image forming apparatus according to claim 9, wherein said retracting portion has a distal end portion formed in an acute angle shape.

12. The image forming apparatus according to claim 1, wherein said medium guiding portion further includes a retracting portion disposed on an end portion thereof on a downstream side in the transportation direction, said retracting portion having a distal end portion situated at a position closer to the first transportation member than an extended plane including the second transportation member.

13. The image forming apparatus according to claim 12, wherein said guide surface is arranged in an inclined state by a blunt angle relative to the extended plane.

14. The image forming apparatus according to claim 12, wherein said the second transportation member is arranged so that the extended plane extends substantially in parallel to the transportation direction.

15. The image forming apparatus according to claim 8, wherein said belt member includes an intermediate transfer belt.

16. The image forming apparatus according to claim 12, wherein said guide surface is arranged at a position closer to the first transportation member than the extended plane.

17. The image forming apparatus according to claim 12, wherein said first transportation member and said second transportation member are arranged so that a line between center points of the first transportation member and the second transportation member is inclined by an acute angle relative to the extended plane.

18. The image forming apparatus according to claim 12, wherein said retracting portion is arranged to be freely rotatable relative to a main body portion of medium guiding portion, said retracting portion having a distal end portion to be situated at a position close to one of the first transportation member and the second transportation member than the extended plane when the retracting portion rotates.

19. The image forming apparatus according to claim 9, further comprising an urging member for urging the retracting portion toward the first transportation member.

20. The image forming apparatus according to claim 9, further comprising a medium detection unit for detecting the medium and a drive unit for driving the retracting portion so that a distal end portion of the retracting portion is situated at a position close to one of the first transportation member and the second transportation member when the medium detection unit detects the medium.
